(19) United States
(12) Patent Application Publication
(10) Pub. No.: US 2008/0053317 A1
(43) Pub. Date: Mar. 6, 2008

(54) Method and device for cooking foodstuff with steam

(75) Inventors: Barbara Estermann, Zug (CH); Nina Dohner, Thalwil (CH); Fritz Zuber, Unterageri (CH)

Correspondence Address: Olson & Cepuritis, LTD., 20 NORTH WACKER DRIVE, 36TH FLOOR, CHICAGO, IL, 60606, US

(73) Assignee: V-ZUG AG, Zug (CH)

(21) Appl. No.: 11/894,119

(22) Filed: Aug. 20, 2007

(30) Foreign Application Priority Data
Aug. 24, 2006 (EP) 06 017 596.5

(51) Int. Cl. A47J 27/04

(52) U.S. Cl. 99/468; 99/473

(57) ABSTRACT

A cooking device comprises a steam generator feeding steam to a cooking chamber. A heater allows to heat the steam in the cooking chamber to a temperature above 100° C. A measuring opening is arranged at the cooking chamber, and a temperature sensor is located at an exit side of the measuring opening. When the temperature at the temperature sensor exceeds a threshold, a second opening arranged at the cooking chamber is opened to release gas from the cooking chamber. This allows to maintain a substantially pure steam atmosphere within the cooking chamber.

### CROSS REFERENCE TO RELATED APPLICATIONS

This application claims the priority of European patent application 06017596.5, filed Aug. 24, 2006, the disclosure of which is incorporated herein by reference in its entirety.

### BACKGROUND OF THE INVENTION

The invention relates to a method and a device for cooking foodstuff by means of steam.

EP 1 619 443 describes a method and a device for cooking foodstuff in a cooking chamber with steam. An overpressure sensor is arranged at the cooking chamber, by weans of which overpressure in the cooking chamber can be detected. The overpressure sensor consists of a measurement opening arranged at the cooking chamber as well as a temperature sensor arranged at the exit side of the opening. The device further comprises a closable opening that can be closed automatically, as well as a steam generator, by means of which steam having a temperature of no more than 100° C. can be fed to the cooking chamber.

The device described in EP 1 619 443 can be operated in two different modes, mainly in a hot air mode and a steam cooking mode.

In the hot air mode the steam generator is deactivated and cooking takes place in hot air. When the temperature at the temperature sensor exceeds a given threshold, the closable opening is opened. This allows to carry off steam emerging from foodstuff and to keep the atmosphere in the cooking chamber dry.

In the steam cooking mode the foodstuff is cooked by means of steam. In this case the closable opening is kept closed all the time.

### BRIEF SUMMARY OF THE INVENTION

It is a general object of the invention to provide an improved method and device of this type.

Now, in order to implement these and still further objects of the invention, which will become more readily apparent as the description proceeds, the invention relates to a method for cooking food stuff in a cooking chamber by means of steam, wherein a measuring opening as well as a closable opening are arranged at the cooking chamber, wherein said method comprises the steps of

feeding steam to the cooking chamber,

measuring a temperature Ts at an exit side of said measuring opening, and

opening said closable opening at least partially upon detection of a rise of said temperature Ts above a threshold To.

Similarly, the invention also relates to a cooking device comprising

a cooking chamber,

a steam generator for feeding steam to the cooking chamber,

a measuring opening arranged at the cooking chamber,

a temperature sensor arranged at an exit side of the measuring opening,

a closable opening arranged at the cooking chamber, and

a control unit adapted to open at least partially the closable opening in dependence of a temperature measured by the temperature sensor when cooking the foodstuff by means of steam.

Accordingly, the closable opening is opened in the steam cooking mode at least partially if the temperature at the temperature sensor exceeds a given threshold. This makes it possible to maintain a nearly pure steam atmosphere during steam cooking in the cooking chamber. If, for example, gases emerge from the foodstuff, these generate an overpressure that causes the closable opening to be opened, such that at least part of the undesired gases are released from the cooking chamber and can be replaced by pure steam.

This procedure is particularly advantageous when the steam in the cooking chamber has a temperature of more than 100° C. It has been found that excellent results can be achieved by means of such “superheated steam”, provided that a substantially pure steam atmosphere can be maintained in the cooking chamber (in particular if the concentration of oxygen is below 2 volume percent).

Advantageously, heating of the steam to temperatures above 100° C. takes place in the cooking chamber. In this case no separate steam heater between the steam generator and the cooking chamber is required.

The invention relates to a method as well as to an oven, the latter having the structural means and a control unit for carrying out the method.

### BRIEF DESCRIPTION OF THE DRAWINGS

The invention will be better understood and objects other than those set forth above will become apparent when consideration is given to the following detailed description thereof. Such description makes reference to the annexed drawing. This drawing shows a schematic view of the most important components of a cooking device.

### DETAILED DESCRIPTION OF THE INVENTION

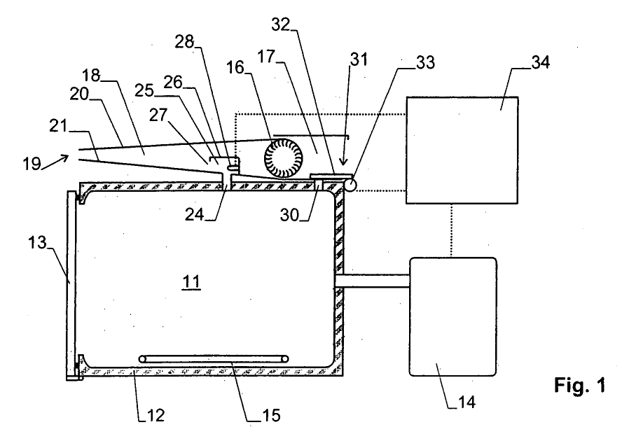

The cooking device of FIG. 1 comprises a cooking chamber 11, which is enclosed by walls 12 and a door 13. The shown cooking device can be used as an oven as well as a steam cooker. It comprises a conventional resistor heater 15 (which can, as shown, be arranged inside the cooking chamber 11, but also outside the cooking chamber 11). The heater 15 is used to heat up the foodstuff in the cooking chamber. Further, the device comprises a steam generator 14, as it is e.g. described in EP 1 166 694.

A cross-flow fan 16 is arranged as a blower outside the cooking chamber 11. Depending on available space, other types of blowers can be used, such as radial fans. The blower feeds air from an intake region 17 to an overpressure region 18. From the overpressure region 18 the air exits through a front-side exit opening 19 of the device. The overpressure region 18 is formed by an inclined cover plate 20 and by an oppositely inclined floor plate 21, such that it becomes narrower towards the exit opening 19. On its sides the overpressure region is closed by lateral walls (not shown). Using an overpressure region that becomes narrower towards the exit opening 19 is not strictly necessary. It is also possible to arrange the cover plate 20 at the floor plate 21 in substantially parallel manner.

Two openings 24 and 30 are arranged at the top of the cooking chamber 11. Opening 30 has a diameter of approximately 2.5 cm, opening 24 is advantageously smaller.

The first opening 24, which serves as a measurement opening, leads from the cooking chamber 11 to the interior 25 of a protective housing 26. The protective housing 26 is arranged in the overpressure region 18 and communicates with the same through a connecting opening 27. The connecting opening 27 is located at the side of the protective housing 26 that faces away from the blower 16. A temperature sensor 28 is arranged within the protective housing 26 at the exit side (i.e. outside cooking chamber 11) of first opening 24. The first opening 24 is kept open all the time.

A second, closable opening 30 connects the cooking chamber 11 with the intake of region 17 in front of the blower 16. A closing mechanism 31 is provided for closing the second opening 30. It comprises a closing door 32 and a stepper motor or servo drive 33 for moving the closing door 32 partially or completely over the second opening 30, such that second opening 30 can be fully opened, fully closed, or partially opened in substantially continuous manner. It is also possible to use a mechanism where closing door 32 can be either fully closed or fully opened only. In that case intermediate positions of the closing door 32 can be emulated by repetitive opening and closing of the closing door 32 as in a pulse-width modulation.

A control unit 34 is provided for controlling the steam generator 14, the closing mechanism 31 and the further components of the cooking device. Control unit 34 monitors, inter alia, the temperature signal generated by temperature sensor 28.

In operation of the cooking device, the blower 16 is operated continuously. It sucks environmental air through openings in the back wall and the lateral walls of the device. This air passes through the intake region 17, is fed to the overpressure region 18 and leaves the same through exit opening 19. Since the overpressure region 18 becomes narrower towards the exit opening 19, a slight overpressure is generated, i.e. a pressure slightly higher than the environmental pressure.

A further purpose of the blower 16 is to expulse air heated at the outside of the cooking chamber from the device, thereby cooling the device.

The method of operation of the cooking device depends on how it is used, namely as conventional hot-air oven or as a steam cooker.

The operation as a hot-air oven is described in EP 1 619 443. The description of this operation in paragraphs 0017 through 0024 and FIG. 2 of EP 1 619 443 are incorporated herein by reference.

Simply said, during operation as a hot-air oven steam generator 14 remains switched off and cooking chamber 11 is heated by means of heater 15. If the temperature Ts of the gas exiting through opening 24 rises above a threshold Tr, opening 30 is opened. This can e.g. occur if a large amount of steam emerges from the foodstuff. This steam can be carried off through opening 30. In this manner, any excess steam is carried off from the cooking chamber 11.

When operating the device as a steam cooker, two different modes of operation can be used:
On the one hand the device can be operated in the manner described in EP 1 619 443, where opening 30 is kept closed by closing mechanism 31. The power fed to steam generator 14 is controlled in the manner described in EP 1 166 694 by measuring the temperature Ts at temperature sensor 28. In this case the steam in the cooking chamber 11 is advantageously not superheated.
Alternatively, the device can be operated in the mode according to the present invention as described in the following.

In the mode according to the present invention the steam generator 14 is in operation. At the same time, however, opening 30 is not closed permanently, as in EP 1 619 443, but opening 30 is opened at least partially by control unit 34 if the temperature Ts at the exit side of the opening 24 exceeds a threshold To. In this manner it is made sure that the gas generated in cooking chamber 11 and giving rise to an overpressure therein is carried off. For example, gases emerging from the foodstuff are carried off. Furthermore this allows to keep the oxygen level in the cooking chamber low, such that no undesired oxidation (e.g. of vitamins, anti-oxidants etc.) takes place.

A particularly advantageous embodiment of this mode of operation uses superheated steam as described in the following.

The cooking of foodstuff in superheated steam, i.e. steam having a temperature of more than 100° C., has various advantages. In particular, superheated steam allows to heat foodstuff quickly because it condenses at the surface of cold foodstuff thereby releasing a large amount of heat. In addition, superheated steam is able to extract humidity from the foodstuff.

Advantageously, the steam is only superheated after it enters cooking chamber 11. In other words, the steam generated by steam generator 14 is not (or only slightly) further heated after evaporation and before entry into the cooking chamber 11. Rather, heater 15 is also operated during steam cooking and used to heat the steam to a temperature well above 100° C., in particular above 200° C.

At the same time the temperature Ts at the temperature sensor 28 is measured. This temperature is used for controlling the closing mechanism 31 and also, advantageously, for controlling the steam generator 14.

The closing mechanism 31 is opened when the temperature Ts exceeds a threshold To. The threshold To is at least 90° C., advantageously approximately 100° C. This causes gas to be carried off from the cooking chamber 11 through opening 30 until the pressure in the cooking chamber 11 falls to a level where no more gas exits through opening 24 and therefore the temperature Ts falls below the threshold To. In this manner new steam is repetitively fed to the cooking chamber at regular intervals, which allows to maintain a substantially pure steam atmosphere within the cooking chamber and, in particular, to keep the oxygen level low. Advantageously the concentration of oxygen in the cooking chamber remains below 2 volume percent.

It must be noted that, in this procedure, the pressure in the cooking chamber 11 does not exceed the environmental pressure at any time because gases can exit from the cooking chamber through opening 24 as well as (if opened) through opening 30.

The steam generator 14 is advantageously also controlled through temperature Ts. If temperature Ts is below a threshold Td, steam generator 14 is set into operation and generates a steam. If temperature Ts is above threshold Td, steam generator 14 is switched off. The threshold Td is advantageously below the boiling temperature of water but is advantageously at least 90° C. As a rule, it is lower than the threshold To.

Advantageously, different programs are stored in control unit 34 for operating the device. These programs describe especially advantageous processing steps for certain foodstuffs. In the following some such processing steps are described:

### EXAMPLE 1

### Frozen Foodstuff

In the first step superheated steam with a temperature off at least 160° C. is generated in the cooking chamber during some minutes. Closing mechanism 31 is controlled in the manner described above by means of temperature Ts. In this step the foodstuff is unfrozen quickly.

In a second step steam generator 14 is switched off and the temperature of the cooking chamber is kept at more than 160° C. for several minutes by means of heater 15. Closing mechanism 31 is kept open all the time.

### EXAMPLE 2

### Gratins

The steam generator 14 feeds steam to the cooking chamber, where the steam is heated to the temperature of more than 160° C. The gratin is cooked under these conditions. Closing mechanism 31 is operated in the manner described above by means of temperature Ts.

### EXAMPLE 3

### Poached Fish

Steam is fed to the cooking chamber by means of steam generator 14. In the cooking chamber the steam is heated to a temperature of 110 to 160° C. to heat up the fish quickly. The closing mechanism 31 is controlled in the manner described above by means of the temperature Ts. Under these conditions the protein denaturizes quickly and does not emerge from the fish. In a second phase cooking of the fish is finished at a temperature of 80 to 100° C., while the steam generator remains switched on and controls the temperature to be at the temperature Td. Closing mechanism 31 is closed.

### EXAMPLE 4

### Cake

In a first step the cake is exposed to dry hot air in the cooking chamber at a temperature above 160° C., whereby the surface is dried.

In a second step superheated steam of a temperature above 160° is generated in the cooking chamber. Closing mechanism 31 is operated in the manner described above by means of temperature Ts. In this step the cake is cooked.

As the above examples above show, a phase where superheated steam is generated in the cooking chamber 11 can precede, follow or replace a conventional cooking phase with dry hot air or conventional steam cooking.

While there are shown and described presently preferred embodiments of the invention, it is to be distinctly understood that the invention is not limited thereto but may be otherwise variously embodied and practised within the scope of the following claims.

1. A method for cooking foodstuff in a cooking chamber by means of steam, wherein a measuring opening as well as a closable opening are arranged at the cooking chamber, wherein said method comprises the steps of
feeding steam to the cooking chamber,
measuring a temperature Ts at an exit side of said measuring opening, and
opening said closable opening at least partially upon detection of a rise of said temperature Ts above a threshold To.

2. The method of claim 1, wherein the steam is heated to a temperature above 100° C. in the cooking chamber.

3. The method of claim 1, wherein the steam is heated to a temperature above 200° C.

4. The method of claim 1, wherein the steam is heated to a temperature above 200° C. in the cooking chamber.

5. The method of claim 2, wherein the steam is heated to a temperature above 200° C. in the cooking chamber.

6. The method of claim 1 wherein a substantially pure steam atmosphere is generated in the cooking chamber.

7. The method of claim 1 wherein a steam atmosphere with less than 2 volume percent of pure oxygen is generated in the cooking chamber.

8. The method of claim 1 wherein the closable opening is kept closed when the temperature Ts is below the threshold To.

9. The method of claim 1 wherein the threshold To is at least 90° C.

10. The method of claim 1 wherein the threshold To is at least 100° C.

11. The method of claim 1 wherein the steam generator is activated to generate steam when the temperature Ts falls below a threshold Td.

12. The method of claim 11 wherein the threshold Td is below the boiling temperature of water.

13. The method of claim 11 wherein the threshold Td is above 90° C.

14. The method of claim 1 wherein the measuring opening exits into an overpressure region, wherein an overpressure is generated in the overpressure region by means of a blower.

15. The method of claim 1 wherein the closable opening exits into an intake region of a blower.

16. The cooking device comprising
a cooking chamber,
a steam generator for feeding steam to the cooking chamber,
a measuring opening arranged at the cooking chamber
a temperature sensor arranged at an exit side of the measuring opening,
a closable opening arranged at the cooking chamber, and
a control unit adapted to activate the steam generator for cooking the foodstuff by means of steam and, while cooking the foodstuff by means of steam, to open at least partially the closable opening in dependence of a temperature measured by the temperature sensor.
